(19) United States
(12) Patent Application Publication
(10) Pub. No.: US 2025/0251372 A1
(43) Pub. Date: Aug. 7, 2025

(54) METHODS FOR CHARACTERIZING FREE THIOL GROUPS IN A PROTEIN

(71) Applicant: Regeneron Pharmaceuticals, Inc., Tarrytown, NY (US)

(72) Inventors: Xiaoxiao Huang, San Diego, CA (US); Xin Wang, Croton-on-Hudson, NY (US); Shunhai Wang, Scarsdale, NY (US); Ning Li, New Canaan, CT (US)

(73) Assignee: Regeneron Pharmaceuticals, Inc., Tarrytown, NY (US)

(21) Appl. No.: 19/040,923

(22) Filed: Jan. 30, 2025

Related U.S. Application Data
(60) Provisional application No. 63/627,907, filed on Feb. 1, 2024.

(51) Int. Cl. G01N 30/72; G01N 30/02; G01N 30/88

(52) U.S. Cl. CPC G01N 30/7233; G01N 2030/027; G01N 2030/8831

(57) ABSTRACT

Described herein are methods of characterizing free thiol species in a protein or peptide. For example, described herein are methods of using hydrophilic interaction chromatography (HILIC) in combination with one or more mass spectrometers to characterize free thiol species in a protein or peptide. Also described herein are methods for characterizing free thiol species in an antibody, such as a therapeutic antibody.

### CROSS-REFERENCE TO RELATED APPLICATION

This application claims priority to U.S. Provisional Patent Application No. 63/627,907, filed on Feb. 1, 2024, which is hereby incorporated by reference in its entirety.

### TECHNICAL FIELD

This disclosure is directed to methods for characterizing and monitoring free thiol groups in amino acid chains of proteins.

### INTRODUCTION

Cysteine residues are vital for protein structure and function. In therapeutic monoclonal antibodies (mAbs), cysteine residues are integral to the formation of conserved intrachain disulfide bonds, which are important for their folding and structural stabilization. Monitoring free thiol groups in mAbs can indicate incomplete disulfide bond formation, potentially impacting drug potency and stability. Free thiol quantitation has been achieved using labeling strategies such as maleimide derivatives at both intact and peptide levels. However, measurement at the intact level only provides an overall free thiol level and does not provide site-specific information, whereas measurement at the peptide level is often time-consuming. Thus, there exists a need for more efficient systems and methods of monitoring intrachain free thiol groups in mAbs without sacrificing accuracy.

### SUMMARY

Provided herein are methods and systems for characterizing free thiol species in a protein.

In some embodiments, the method may comprise contacting a sample including a protein and at least one free thiol species thereof to a hydrophilic interaction chromatography (HILIC) system to produce an eluate; contacting the eluate to a mass spectrometer to generate a mass measurement of the protein and a mass measurement of the at least one free thiol species; and comparing the mass measurement of the at least one free thiol species to the mass measurement of the protein to characterize the at least one free thiol species.

In some aspects, the protein may be or comprise an antibody, an antibody fragment, an antibody fragment, an antibody-drug conjugate, a fusion protein, or a recombinant protein. The antibody may be a monoclonal antibody, a bispecific antibody, or a monoclonal bispecific antibody.

In some aspects, the HILIC system may be coupled to a mass spectrometer. The mass spectrometer may be or comprise an electrospray ionization mass spectrometer, a nano-electrospray ionization mass spectrometer, or an Orbitrap-based mass spectrometer. The mass spectrometer may be or comprise a tandem mass spectrometer. In some aspects, the tandem mass spectrometer is configured to perform electron-transfer dissociation, collision-induced dissociation, electron-transfer/collision-induced dissociation, electron-transfer/higher-energy collisional dissociation, ultra-violet photodissociation, or a combination thereof.

In some aspects, contacting the eluate to a mass spectrometer to generate a mass measurement of the protein and a mass measurement of the at least one free thiol species may comprise generating a mass spectrum for the protein and a mass spectrum for the at least one free thiol species. Contacting the eluate to a mass spectrometer to generate a mass measurement of the protein and a mass measurement of the at least one free thiol species may comprise generating, for the protein, a mass spectrum and an extracted ion chromatogram; and generating, for the at least one free thiol species, a mass spectrum and an extracted ion chromatogram.

In some embodiments, the method may comprise: contacting a sample including a protein and at least one free thiol species thereof to deglycosylation conditions to produce a deglycosylated sample; contacting the deglycosylated sample to a hydrophilic interaction chromatography (HILIC) system to produce an eluate; contacting the eluate to a mass spectrometer to generate a mass measurement of the protein and a mass measurement of the at least one free thiol species; and comparing the mass measurement of the at least one free thiol species to the mass measurement of the protein to characterize the at least one free thiol species.

In some aspects, the protein may be or comprise an antibody, an antibody fragment, an antibody fragment, an antibody-drug conjugate, a fusion protein, or a recombinant protein. The antibody may be a monoclonal antibody, a bispecific antibody, or a monoclonal bispecific antibody.

In some aspects, the HILIC system may be coupled to a mass spectrometer. The mass spectrometer may be or comprise an electrospray ionization mass spectrometer, a nano-electrospray ionization mass spectrometer, or an Orbitrap-based mass spectrometer. The mass spectrometer may be or comprise a tandem mass spectrometer. In some aspects, the tandem mass spectrometer is configured to perform electron-transfer dissociation, collision-induced dissociation, electron-transfer/collision-induced dissociation, electron-transfer/higher-energy collisional dissociation, ultra-violet photodissociation, or a combination thereof.

In some aspects, contacting a sample including a protein and at least one free thiol species thereof to deglycosylation conditions to produce a deglycosylated sample may comprise contacting the sample to an enzyme that can carry out deglycosylation.

In some aspects, contacting a sample including a protein and at least one free thiol species thereof to deglycosylation conditions to produce a deglycosylated sample may comprise contacting the sample to peptide-N-glycosidase F (PNGase F).

### BRIEF DESCRIPTION OF THE DRAWINGS

The accompanying drawings, which are incorporated in and constitute a part of this specification, illustrate various examples and together with the description, serve to explain the principles of the disclosed examples and embodiments.

Aspects of the disclosure may be implemented in connection with embodiments illustrated in the attached drawings. These drawings show different aspects of the present disclosure and, where appropriate, reference numerals illustrating like structures, components, materials, and/or elements in different figures are labeled similarly. It is understood that various combinations of the structures, components, and/or elements, other than those specifically shown, are contemplated and are within the scope of the present disclosure.

Moreover, there are many embodiments described and illustrated herein. The present disclosure is neither limited to any single aspect nor embodiment thereof, nor to any combinations and/or permutations of such aspects and/or embodiments. Moreover, each of the aspects of the present disclosure, and/or embodiments thereof, may be employed alone or in combination with one or more of the other aspects of the present disclosure and/or embodiments thereof. For the sake of brevity, certain permutations and combinations are not discussed and/or illustrated separately herein. Notably, an embodiment or implementation described herein as “exemplary” is not to be construed as preferred or advantageous, for example, over other embodiments or implementations; rather, it is intended reflect or indicate the embodiment(s) is/are “example” embodiment(s).

FIG. 1 is a graph depicting results of an exemplary method for analyzing subunits of a protein using HILIC-FLR, according to aspects of the present disclosure.

FIGS. 2A-2B are mass spectra and deconvoluted mass spectra depicting results of an exemplary method for characterizing free thiol species of a monoclonal antibody, according to aspects of the present disclosure. FIG. 2A depicts a mass spectra for an LC subunit of the monoclonal antibody. FIG. 2B depicts mass spectra for an Fc/2 subunit of the monoclonal antibody.

FIG. 3 is a panel of extracted ion chromatograms of mass spectra depicting results of an exemplary method for characterizing free thiol species of an Fc/2 subunit of a monoclonal antibody, according to aspects of the present disclosure.

FIGS. 4A-4C are annotated sequence illustrations depicting fragmentation patterns, disulfide linkages, and N-glycosylation sites in an Fc/2 subunit of a monoclonal antibody, according to aspects of the present disclosure. FIG. 4A depicts these features for the Fc/2 subunit. FIG. 4B depicts these features for the Fc/2 subunit with CH2 free thiol. FIG. 4C depicts these features for the Fc/2 subunit with CH3 free thiol.

FIG. 5 is a graph depicting results of an exemplary method for characterizing free thiol percentage as a function of time, according to aspects of the present disclosure.

FIG. 6 is a graph depicting results of an exemplary method for characterizing site-specific free thiol percentage as a function of middle-up HILIC free thiol percentage, according to aspects of the present disclosure.

FIG. 7 is a panel of five graphs depicting results of two exemplary processes for characterizing free thiol percentage as a function of time, according to aspects of the present disclosure.

### DETAILED DESCRIPTION

This disclosure provides a middle-up HILIC-MS method that separates free thiol species from main species at the subunit level, allowing for the identification and quantitation of intrachain free thiols quickly and confidently.

Unless described otherwise, all technical and scientific terms used herein have the same meaning as commonly understood by one of ordinary skill in the art. Although any methods and materials similar or equivalent to those described herein can be used in the practice or testing, particular methods and materials are now described. All publications mentioned are hereby incorporated by reference.

As used herein, the term “a” means “at least one”; and the terms “about” and “approximately” should be understood to permit standard variation as would be understood by those of ordinary skill in the art. Where ranges are provided, endpoints are included.

As used herein, the terms “protein” or “protein of interest” can include any amino acid polymer having covalently linked amide bonds. Proteins comprise one or more amino acid polymer chains, generally known in the art as “polypeptides.” “Polypeptide” refers to a polymer composed of amino acid residues, related naturally occurring structural variants, and synthetic non-naturally occurring analogs thereof linked via peptide bonds. “Synthetic peptide or polypeptide” refers to a non-naturally occurring peptide or polypeptide. Synthetic peptides or polypeptides can be synthesized, for example, using an automated polypeptide synthesizer. Various solid phase peptide synthesis methods are known to those of skill in the art. A protein may comprise one or multiple polypeptides to form a single functioning biomolecule. A protein may be simple polypeptides consisting of a single subunit, or complex multi-subunit proteins comprising two or more subunits. In another exemplary aspect, a protein can include antibody fragments, nanobodies, recombinant antibody chimeras, cytokines, chemokines, peptide hormones, and the like. Proteins of interest can include any of bio-therapeutic proteins, recombinant proteins used in research or therapy, trap proteins and other chimeric receptor Fc-fusion proteins, chimeric proteins, antibodies, monoclonal antibodies, polyclonal antibodies, human antibodies, and bispecific antibodies. Proteins may be produced using recombinant cell-based production systems, such as the insect bacculovirus system, yeast systems (e.g., Pichia sp.), and mammalian systems (e.g., CHO cells and CHO derivatives like CHO-K1 cells). For a recent review discussing biotherapeutic proteins and their production, see Ghaderi et al., “Production platforms for biotherapeutic glycoproteins. Occurrence, impact, and challenges of non-human sialylation”, Biotechnology and Genetic Engineering Reviews, 2012, Volume 28, Pages 147-176, the entire teachings of which are herein incorporated by reference. In some exemplary embodiments, proteins comprise modifications, adducts, and other covalently linked moieties. These modifications, adducts, and moieties include, for example, avidin, streptavidin, biotin, glycans (e.g., N-acetylgalactosamine, galactose, neuraminic acid, N-acetylglucosamine, fucose, mannose, and other monosaccharides), PEG, polyhistidine, FLAGtag, maltose binding protein (MBP), chitin binding protein (CBP), glutathione-S-transferase (GST) myc-epitope, fluorescent labels and other dyes, and the like. Proteins can be classified on the basis of compositions and solubility and can thus include simple proteins, such as globular proteins and fibrous proteins; conjugated proteins, such as nucleoproteins, glycoproteins, mucoproteins, chromoproteins, phosphoproteins, metalloproteins, and lipoproteins; and derived proteins, such as primary derived proteins and secondary derived proteins.

In some exemplary embodiments, the protein of interest can be a recombinant protein, an in vivo product of gene therapy, a therapeutic protein, an antibody, a bispecific antibody, a multi-specific antibody, antibody fragment, monoclonal antibody, antigen-binding protein, fusion protein, scFv, a multi-subunit protein, a receptor, a receptor ligand, and combinations thereof.

As used herein, the term “therapeutic protein” refers to any protein that can be administered to a subject for the treatment of a disease or disorder. A therapeutic protein may be any protein with a pharmacological effect, for example, an antibody, a soluble receptor, an antibody-drug conjugate, an antigen-binding protein, or an enzyme. In some exemplary embodiments, the therapeutic protein can be a monoclonal antibody.

As used herein, the term “recombinant protein” refers to a protein produced as the result of the transcription and translation of a gene carried on a recombinant expression vector that has been introduced into a suitable host cell. In certain exemplary embodiments, the recombinant protein can be an antibody, for example, a chimeric, humanized, or fully human antibody. In certain exemplary embodiments, the recombinant protein can be an antibody of an isotype selected from group consisting of: IgG, IgM, IgA1, IgA2, IgD, or IgE. In certain exemplary embodiments the antibody molecule is a full-length antibody (e.g., an IgG1) or alternatively the antibody can be a fragment (e.g., an Fc fragment or a Fab fragment).

As used herein, the term “antibody” includes immunoglobulin molecules comprising four polypeptide chains, two heavy chains (HC) and two light chains (LC) inter-connected by disulfide bonds, as well as multimers thereof (e.g., IgM). Each heavy chain comprises a heavy chain variable region (abbreviated herein as HCVR or VH) and a heavy chain constant region. The combination of two heavy chain constant regions is referred to as the fragment crystallizable (Fc) region or Fc. The heavy chain constant region comprises three domains, CH1, CH2 and CH3. The combination of the VH and CH1 domains is referred to as the Fd region or Fd. Each light chain comprises a light chain variable region (abbreviated herein as LCVR or VL) and a light chain constant region. The light chain constant region comprises one domain (CL1 or CL). The VH and VL regions can be further subdivided into regions of hypervariability, termed complementarity determining regions (CDRs), interspersed with regions that are more conserved, termed framework regions (FR). Each VH and VL is composed of three CDRs and four FRs, arranged from amino-terminus to carboxy-terminus in the following order: FR1, CDR1, FR2, CDR2, FR3, CDR3, and FR4. In different embodiments of the present invention, the FRs of the anti-big-ET-1 antibody (or antigen-binding portion thereof) may be identical to the human germline sequences or may be naturally or artificially modified. An amino acid consensus sequence may be defined based on a side-by-side analysis of two or more CDRs. The term “antibody,” as used herein, also includes antigen-binding fragments of full antibody molecules. The terms “antigen-binding portion” of an antibody, “antigen-binding fragment” of an antibody, and the like, as used herein, include any naturally occurring, enzymatically obtainable, synthetic, or genetically engineered polypeptide or glycoprotein that specifically binds an antigen to form a complex. Antigen-binding fragments of an antibody may be derived, for example, from full antibody molecules using any suitable standard techniques such as proteolytic digestion or recombinant genetic engineering techniques involving the manipulation and expression of DNA encoding antibody variable and optionally constant domains. Such DNA is known and/or is readily available from, for example, commercial sources, DNA libraries (including, e.g., phage-antibody libraries), or can be synthesized. The DNA may be sequenced and manipulated chemically or by using molecular biology techniques, for example, to arrange one or more variable and/or constant domains into a suitable configuration, or to introduce codons, create cysteine residues, modify, add or delete amino acids, etc.

As used herein, the term “antibody fragment” refers to a portion of an intact antibody, such as, for example, the antigen-binding or variable region of an antibody. Examples of antibody fragments include, but are not limited to, a Fab fragment, a Fab′ fragment, a F(ab′)2 fragment, a Fc fragment, a Fc/2 fragment, a scFv fragment, a Fv fragment, a dsFv diabody, a dAb fragment, a Fd′ fragment, a Fd fragment, and an isolated complementarity determining region (CDR) region, as well as triabodies, tetrabodies, linear antibodies, single-chain antibody molecules, and multi specific antibodies formed from antibody fragments. Fv fragments are the combination of the variable regions of the immunoglobulin heavy and light chains, and ScFv proteins are recombinant single chain polypeptide molecules in which immunoglobulin light and heavy chain variable regions are connected by a peptide linker. In some exemplary embodiments, an antibody fragment comprises a sufficient amino acid sequence of the parent antibody of which it is a fragment that it binds to the same antigen as does the parent antibody. In some exemplary embodiments, a fragment binds to the antigen with a comparable affinity to that of the parent antibody and/or competes with the parent antibody for binding to the antigen. An antibody fragment may be produced by any means. For example, an antibody fragment may be enzymatically or chemically produced by fragmentation of an intact antibody and/or it may be recombinantly produced from a gene encoding the partial antibody sequence. Alternatively, or additionally, an antibody fragment may be wholly or partially synthetically produced. An antibody fragment may optionally comprise a single chain antibody fragment. Alternatively, or additionally, an antibody fragment may comprise multiple chains that are linked together, for example, by disulfide linkages. An antibody fragment may optionally comprise a multi-molecular complex. A functional antibody fragment typically comprises at least about 50 amino acids and more typically comprises at least about 200 amino acids.

As used herein, the term “bispecific antibody” includes an antibody capable of selectively binding two or more epitopes. Bispecific antibodies generally comprise two different heavy chains with each heavy chain specifically binding a different epitope-either on two different molecules (e.g., antigens) or on the same molecule (e.g., on the same antigen). If a bispecific antibody is capable of selectively binding two different epitopes (a first epitope and a second epitope), the affinity of the first heavy chain for the first epitope will generally be at least one to two or three or four orders of magnitude lower than the affinity of the first heavy chain for the second epitope, and vice versa. The epitopes recognized by the bispecific antibody can be on the same or a different target (e.g., on the same or a different protein). Bispecific antibodies can be made, for example, by combining heavy chains that recognize different epitopes of the same antigen. For example, nucleic acid sequences encoding heavy chain variable sequences that recognize different epitopes of the same antigen can be fused to nucleic acid sequences encoding different heavy chain constant regions and such sequences can be expressed in a cell that expresses an immunoglobulin light chain.

A typical bispecific antibody has two heavy chains each having three heavy chain CDRs, followed by a CH1 domain, a hinge, a CH2 domain, and a CH3 domain, and an immunoglobulin light chain that either does not confer antigen-binding specificity but that can associate with each heavy chain, or that can associate with each heavy chain and that can bind one or more of the epitopes bound by the heavy chain antigen-binding regions, or that can associate with each heavy chain and enable binding of one or both of the heavy chains to one or both epitopes. Bispecific antibodies can be divided into two major classes, those bearing an Fc region (IgG-like) and those lacking an Fc region, the latter normally being smaller than the IgG and IgG-like bispecific molecules comprising an Fc region. The IgG-like bispecific antibodies can have different formats such as, but not limited to, triomab, knobs into holes IgG (kih IgG), crossMab, orth-Fab IgG, Dual-variable domains Ig (DVD-Ig), two-in-one or dual action Fab (DAF), IgG-single-chain Fv (IgG-scFv), or κλ-bodies. The non-IgG-like different formats include tandem scFvs, diabody format, single-chain diabody, tandem diabodies (TandAbs), Dual-affinity retargeting molecule (DART), DART-Fc, nanobodies, or antibodies produced by the dock-and-lock (DNL) method. For more information, see Fan et al., “Bispecific antibodies and their applications”, Journal of Hematology & Oncology, 2015, Volume 8, Article No. 130, Pages 1-14; and see Müller et al., “Chapter 11: Bispecific Antibodies”, Handbook of Therapeutic Antibodies, 2014, Pages 265-310, each of which is incorporated herein in its entirety. The methods of producing bispecific antibodies include, but are not limited to, quadroma technology based on the somatic fusion of two different hybridoma cell lines, chemical conjugation involving chemical cross-linkers, and genetic approaches utilizing recombinant DNA technology.

As used herein, the term “multispecific antibody” refers to an antibody with binding specificities for at least two different antigens. While such molecules normally will only bind two antigens (i.e., bispecific antibodies), antibodies with additional specificities such as trispecific antibody and KIH Trispecific can also be addressed by the system and method disclosed herein.

As used herein, the term “monoclonal antibody” includes but is not limited to antibodies produced through hybridoma technology. A monoclonal antibody can be derived from a single clone, including any eukaryotic, prokaryotic, or phage clone, by any means available or known in the art. Monoclonal antibodies useful with the present disclosure can be prepared using a wide variety of techniques known in the art including the use of hybridoma, recombinant, and phage display technologies, or a combination thereof.

As used herein, the term “sample” is one which can be obtained from any step of a bioprocess, such as cell culture fluid (CCF), harvested cell culture fluid (HCCF), any step in the downstream processing, drug substance (DS), or a drug product (DP) comprising the final formulated product. In some specific exemplary embodiments, the sample can be selected from any step of the downstream process of clarification, chromatographic production, or filtration. In some exemplary embodiments, the sample including the protein of interest can be prepared prior to analysis. Preparation steps can include deglycosylation, digestion, denaturing and/or reduction.

As used herein, the term “deglycosylation” refers to the removal of glycans from a protein. Deglycosylated proteins can be useful for mass spectrometry in the case of large and complex antibodies, which may have intrinsic heterogeneity and poor ionization due to glycosylation. In the case of antibodies, deglycosylation refers to the removal of glycans from an Fc fragment. Deglycosylation of a protein in a sample can be done enzymatically or chemically. Non-limiting examples of enzymes that can carry out deglycosylation include PNGaseF. Deglycosylation is typically carried out in a buffer solution, most preferably in Tris-HCl. In some exemplary embodiments, the concentration of Tris-HCl is about 10 mM, about 20 mM, about 30 mM, about 40 mM, about 50 mM, about 60 mM, about 70 mM, about 80 mM, about 90 mM, or about 100 mM. Deglycosylation may also be carried out in ambient (room) temperature or above ambient temperature. In some exemplary embodiments, deglycosylation is carried out at about 25° C., about 37° C., about 45° C., or about 55° C. The deglycosylation mixture may be incubated for a period of time in order to ensure complete deglycosylation. In some exemplary embodiments, the deglycosylation mixture may be incubated for about 2 minutes, about 3 minutes, about 4 minutes, about 5 minutes, about 10 minutes, about 15 minutes, about 30 minutes, about 1 hour, about 2 hours, about 5 hours, or about 10 hours.

As used herein, the term “digestion” refers to hydrolysis of one or more peptide bonds of a protein. There are several approaches to carrying out digestion of a protein in a sample using an appropriate hydrolyzing agent, for example, enzymatic digestion or non-enzymatic digestion.

As used herein, the term “digestive enzyme” refers to any of a large number of different agents that can perform digestion of a protein. Non-limiting examples of hydrolyzing agents that can carry out enzymatic digestion include protease from Aspergillus Saitoi, elastase, subtilisin, protease XIII, pepsin, trypsin, Tryp-N, chymotrypsin, aspergillopepsin I, LysN protease (Lys-N), LysC endoproteinase (Lys-C), endoproteinase Asp-N (Asp-N), endoproteinase Arg-C (Arg-C), endoproteinase Glu-C (Glu-C) or outer membrane protein T (OmpT), immunoglobulin-degrading enzyme of Streptococcus pyogenes (IdeS), IdeZ, igdE, glyserias, thermolysin, papain, pronase, V8 protease or biologically active fragments or homologs thereof or combinations thereof. For a recent review discussing the available techniques for protein digestion see Switzar et al., “Protein Digestion: An Overview of the Available Techniques and Recent Developments”, Journal of Proteome Research, 2013, Volume 12, Issue 3, Pages 1067-1077.

In some exemplary embodiments, IdeS or a variant thereof is used to cleave an antibody below the hinge region, producing an Fc fragment and a Fab₂ fragment. Digestion of an analyte may be advantageous because size reduction may increase the sensitivity and specificity of characterization and detection of the analyte using LC-MS. When used for this purpose, digestion that separates out an Fc fragment and keeps a Fab₂ fragment for analysis may be preferred. This is because variable regions of interest, such as the complementarity-determining region (CDR) of an antibody, are contained in the Fab₂ fragment, while the Fc fragment may be relatively uniform between antibodies and thus provide less relevant information. Alternatively, or additionally, digestion that separates out a Fab₂ fragment and keeps an Fc fragment for analysis may be preferred, because the Fc fragment contains an N-glycosylation site of interest. IdeS digestion has a high efficiency, allowing for high recovery of an analyte. The digestion and elution process may be performed under native conditions, allowing for simple coupling to a native LC-MS system. IdeS or variants thereof are commercially available and may be marketed as, for example, FABRICATOR® or FABRICATOR Z®.

As used herein, the term “protein denaturing” refers to a process in which the three-dimensional shape of a molecule is changed from its native state. Protein denaturation can be carried out using a protein denaturing agent. Non-limiting examples of a protein denaturing agent include heat, high or low pH, reducing agents like DTT (see below) or exposure to chaotropic agents. Several chaotropic agents can be used as protein denaturing agents. Chaotropic solutes increase the entropy of the system by interfering with intramolecular interactions mediated by non-covalent forces such as hydrogen bonds, van der Waals forces, and hydrophobic effects. Non-limiting examples for chaotropic agents include butanol, ethanol, guanidinium chloride, lithium perchlorate, lithium acetate, magnesium chloride, phenol, propanol, sodium dodecyl sulfate, thiourea, N-lauroylsarcosine, urea, and salts thereof.

As used herein, the term “protein reducing agent” refers to the agent used for reduction of disulfide bridges in a protein. Non-limiting examples of protein reducing agents used to reduce a protein are dithiothreitol (DTT), ß-mercaptoethanol, Ellman's reagent, hydroxylamine hydrochloride, sodium cyanoborohydride, tris(2-carboxyethyl)phosphine hydrochloride (TCEP-HCl), or combinations thereof. A conventional method of protein analysis, reduced peptide mapping, involves protein reduction prior to LC-MS analysis. Another method, non-reduced peptide mapping, omits the sample preparation step of reduction in order to preserve endogenous disulfide bonds. In some exemplary embodiments, non-reduced preparation may be used, for example, in order to preserve an endogenous disulfide bond between Fab arms of an antibody or antibody-derived protein. In other exemplary embodiments, partially-reduced preparation may be used, for example, in order to reduce the disulfide bond between Fab arms of an antibody or antibody-derived protein without fully reducing the protein.

As used herein, the term “impurity” can include any undesirable protein present in a protein sample or protein biopharmaceutical product. Impurity can include process-related impurities and product-related impurities. The impurity can further be of known structure, partially characterized, or unidentified.

Process-related impurities can be derived from the manufacturing process and can include the three major categories: cell substrate-derived, cell culture-derived and downstream derived. Cell substrate-derived impurities include, but are not limited to, proteins derived from the host organism and nucleic acid (host cell genomic, vector, or total DNA). Cell culture-derived impurities include, but are not limited to, inducers, antibiotics, serum, and other media components. Downstream-derived impurities include, but are not limited to, enzymes, chemical and biochemical processing reagents (e.g., cyanogen bromide, guanidine, oxidizing and reducing agents), inorganic salts (e.g., heavy metals, arsenic, nonmetallic ion), solvents, carriers, ligands (e.g., monoclonal antibodies), and other leachables.

Product-related impurities (e.g., precursors, certain degradation products) can be molecular variants arising during manufacture and/or storage that do not have properties comparable to those of the desired product with respect to activity, efficacy, and safety. Such variants may need considerable effort in isolation and characterization in order to identify the type of modification(s). Product-related impurities can include truncated forms, modified forms, and aggregates. Truncated forms are formed by hydrolytic enzymes or chemicals which catalyze the cleavage of peptide bonds. Modified forms include, but are not limited to, deamidated, isomerized, mismatched S—S linked, oxidized, or altered conjugated forms (e.g., glycosylation, phosphorylation). Modified forms can also include any post-translational modification form. Aggregates include dimers and higher multiples of the desired product. For more information, see U.S. Department of Health and Human Services, “Q6B Specifications: Test Procedures and Acceptance Criteria for Biotechnological/Biological Products, ICH”, August 1999.

As used herein, the term “chromatography” refers to a process in which a chemical mixture carried by a liquid or gas can be separated into components as a result of differential distribution of the chemical entities as they flow around or over a stationary liquid or solid phase. Non-limiting examples of chromatography include traditional reversed-phased (RP), ion exchange (IEX) and normal phase chromatography (NP). Unlike RP, NP and IEX chromatography, in which hydrophobic interaction, hydrophilic interaction and ionic interaction respectively are the dominant interaction modes, mixed-mode chromatography can employ a combination of two or more of these interaction modes. Several types of liquid chromatography can be used with the mass spectrometer, such as, rapid resolution liquid chromatography (RRLC), ultra-performance liquid chromatography (UPLC), ultra-fast liquid chromatography (UFLC) and nano liquid chromatography (nLC). For further details on chromatography method and principles, see Poole et al., “Liquid Chromatography: Volume 1: Fundamentals and Instrumentation”, Elsevier, 2017. Non-limiting examples of chromatography include gas chromatography, reverse phase liquid chromatography, ion-exchange chromatography, size exclusion chromatography, affinity chromatography, mixed-mode chromatography, hydrophobic chromatography, hydrophilic chromatography or mixed-mode chromatography.

As used herein, the term “affinity chromatography” can include separations including any method by which two substances are separated based their affinity to chromatographic material. It can comprise subjecting the substances to a column comprising a suitable affinity chromatographic media. Non-limiting examples of such chromatographic media include, but are not limited to Protein A resin, Protein G resin, affinity supports comprising the antigen against which the binding molecule was raised, and affinity supports comprising an Fc binding protein. In one aspect, an affinity column can be equilibrated with a suitable buffer prior to sample loading. An example of a suitable buffer can be a Tris/NaCl buffer, pH around 7.2. Following this equilibration, the sample can be loaded onto the column. Following the loading of the column, the column can be washed one or multiple times using, e.g., the equilibrating buffer. Other washes including washes employing different buffers can be used before eluting the column. The affinity column can then be eluted using an appropriate elution buffer. An example of a suitable elution buffer can be an acetic acid/NaCl buffer, pH around 3.5. The eluate can be monitored using techniques well known to those skilled in the art. For example, the absorbance at OD280 can be followed.

As used herein, the term “ion exchange chromatography” can include separations including any method by which two substances are separated based on the difference in their respective ionic charges, either on the molecule of interest and/or chromatographic material as a whole or locally on specific regions of the molecule of interest and/or chromatographic material, and thus can employ either cationic exchange material or anionic exchange material. Ion exchange chromatography separates molecules based on differences between the local charges of the molecules of interest and the local charges of the chromatographic material. A packed ion-exchange chromatography column or an ion-exchange membrane device can be operated in a bind-elute mode, a flow-through, or a hybrid mode. After washing the column or the membrane device with the equilibration buffer or another buffer with different pH and/or conductivity, the product recovery can be achieved by increasing the ionic strength (i.e., conductivity) of the elution buffer to compete with the solute for the charged sites of the ion exchange matrix. Changing the pH and thereby altering the charge of the solute can be another way to achieve elution of the solute. The change in conductivity or pH may be gradual (gradient elution) or stepwise (step elution). The column can be then regenerated before next use. Anionic or cationic substituents may be attached to matrices in order to form anionic or cationic supports for chromatography. Non-limiting examples of anionic exchange substituents include diethylaminoethyl (DEAE), quaternary aminoethyl (QAE) and quaternary amine (Q) groups. Cationic substituents include carboxymethyl (CM), sulfoethyl (SE), sulfopropyl (SP), phosphate (P) and sulfonate (S). Cellulose ion exchange medias or support can include DE23™, DE32™, DE52™ CM-23™, CM-32™, and CM-52™ are available from Whatman Ltd. Maidstone, Kent, U.K. SEPHADEX®-based and -locross-linked ion exchangers are also known. For example, DEAE-, QAE-, CM-, and SP-SEPHADEX® and DEAE-, Q-, CM- and S-SEPHAROSE® and SEPHAROSE® Fast Flow, and CAPTO™ S are all available from GE Healthcare. Further, both DEAE and CM derivitized ethylene glycol-methacrylate copolymer such as TOYOPEARL™ DEAE-650S or M and TOYOPEARL™ CM-650S or M are available from Toso Haas Co., Philadelphia, Pa., or Nuvia S and UNOSphere™ S from BioRad, Hercules, Calif., Eshmuno® S from EMD Millipore, MA.

As used herein, the term “hydrophobic interaction chromatography resin” can include a solid phase which can be covalently modified with phenyl, octyl, or butyl chemicals. It can use the properties of hydrophobicity to separate molecules from one another. In this type of chromatography, hydrophobic groups such as, phenyl, octyl, hexyl or butyl can be attached to the stationary column. Molecules that pass through the column that have hydrophobic amino acid side chains on their surfaces are able to interact with and bind to the hydrophobic groups on the column. Examples of hydrophobic interaction chromatography resins or support include Phenyl sepharose FF, Capto Phenyl (GE Healthcare, Uppsala, Sweden), Phenyl 650-M (Tosoh Bioscience, Tokyo, Japan) and Sartobind Phenyl (Sartorius corporation, New York, USA).

As used herein, the terms “Mixed Mode Chromatography (MMC)” or “multimodal chromatography” include a chromatographic method in which solutes interact with stationary phase through more than one interaction mode or mechanism. MMC can be used as an alternative or complementary tool to traditional reversed-phased (RP), ion exchange (IEX) and normal phase chromatography (NP). Unlike RP, NP and IEX chromatography, in which hydrophobic interaction, hydrophilic interaction and ionic interaction respectively are the dominant interaction modes, mixed-mode chromatography can employ a combination of two or more of these interaction modes. Mixed mode chromatography media can provide unique selectivity that cannot be reproduced by single mode chromatography. Mixed mode chromatography can also provide potential cost savings, longer column lifetimes and operation flexibility compared to affinity-based methods. In some exemplary embodiments, the mixed mode chromatography media can be comprised of mixed mode ligands coupled to an organic or inorganic support, sometimes denoted a base matrix, directly or via a spacer. The support may be in the form of particles, such as essentially spherical particles, a monolith, filter, membrane, surface, capillaries, etc. In some specific exemplary embodiments, the support can be prepared from a native polymer, such as cross-linked carbohydrate material, such as agarose, agar, cellulose, dextran, chitosan, konjac, carrageenan, gellan, alginate and the like. To obtain high adsorption capacities, the support can be porous, and ligands are then coupled to the external surfaces as well as to the pore surfaces. Such native polymer supports can be prepared according to standard methods, such as inverse suspension gelation. See, e.g., Hjerten, “The preparation of agarose spheres for chromatography of molecules and particles”, Biochimica et Biophysica Acta, 1964, Volume 79, Issue 2, Pages 393-398. Alternatively, the support can be prepared from a synthetic polymer, such as cross-linked synthetic polymers, e.g., styrene or styrene derivatives, divinylbenzene, acrylamides, acrylate esters, methacrylate esters, vinyl esters, vinyl amides and the like. Such synthetic polymers can be produced according to standard methods. See, e.g., Arshady, “Styrene based polymer supports developed by suspension polymerization”, La Chimica e l'Industria, 1988, Volume 70, Issue 9, Pages 70-75. Porous native or synthetic polymer supports are also available from commercial sources, such as Amersham Biosciences, Uppsala, Sweden.

As used herein, the terms “hydrophilic interaction chromatography” or “HILIC” refer to a process employing a hydrophilic stationary phase and a hydrophobic organic mobile phase in which hydrophilic compounds are retained longer than hydrophobic compounds. In certain embodiments, the process utilizes a water-miscible solvent mobile phase. In certain embodiments, the term also includes electrostatic repulsion hydrophilic interaction chromatography (ERLIC), Cationic ERLIC, and Anionic ERLIC.

In some exemplary embodiments, the hydrophilic interaction chromatography system is coupled to the mass spectrometer. As used herein, the term “mass spectrometer” includes a device capable of identifying specific molecular species and measuring their accurate masses. The term is meant to include any molecular detector into which a polypeptide or peptide may be eluted for detection and/or characterization. A mass spectrometer can include three major parts: the ion source, the mass analyzer, and the detector. The role of the ion source is to create gas phase ions. Analyte atoms, molecules, or clusters can be transferred into gas phase and ionized either concurrently (as in electrospray ionization) or through separate processes. The choice of ion source depends heavily on the application.

In some exemplary embodiments, the mass spectrometer can be a tandem mass spectrometer. As used herein, the term “tandem mass spectrometry” includes a technique where structural information on sample molecules is obtained by using multiple stages of mass selection and mass separation. A prerequisite is that the sample molecules can be transferred into gas phase and ionized intact and that they can be induced to fall apart in some predictable and controllable fashion after the first mass selection step. Multistage MS/MS, or MSⁿ, can be performed by first selecting and isolating a precursor ion (MS²), fragmenting it, isolating a primary fragment ion (MS³), fragmenting it, isolating a secondary fragment (MS⁴), and so on as long as one can obtain meaningful information, or the fragment ion signal is detectable. Tandem MS has been successfully performed with a wide variety of analyzer combinations. What analyzers to combine for a certain application can be determined by many different factors, such as sensitivity, selectivity, and speed, but also size, cost, and availability. The two major categories of tandem MS methods are tandem-in-space and tandem-in-time, but there are also hybrids where tandem-in-time analyzers are coupled in space or with tandem-in-space analyzers. A tandem-in-space mass spectrometer comprises an ion source, a precursor ion activation device, and at least two non-trapping mass analyzers. Specific m/z separation functions can be designed so that in one section of the instrument ions are selected, dissociated in an intermediate region, and the product ions are then transmitted to another analyzer for m/z separation and data acquisition. In tandem-in-time, mass spectrometer ions produced in the ion source can be trapped, isolated, fragmented, and m/z separated in the same physical device. In some exemplary embodiments, the mass spectrometer can be a tandem mass spectrometer.

As used herein, the term “tandem mass spectrometry” further includes a technique where structural information on sample molecules is obtained by using multiple stages of mass selection and mass separation. A prerequisite is that the sample molecules be transformed into a gas phase and ionized so that fragments are formed in a predictable and controllable fashion after the first mass selection step. MS/MS, or MS², can be performed by first selecting and isolating a precursor ion (MS¹), and fragmenting it to obtain meaningful information. Tandem MS has been successfully performed with a wide variety of analyzer combinations. Which analyzers to combine for a certain application can be determined by many different factors, such as sensitivity, selectivity, and speed, but also size, cost, and availability. The two major categories of tandem MS methods are tandem-in-space and tandem-in-time, but there are also hybrids where tandem-in-time analyzers are coupled in space or with tandem-in-space analyzers. A tandem-in-space mass spectrometer comprises an ion source, a precursor ion activation device, and at least two non-trapping mass analyzers.

Tandem mass spectrometry may produce ion series depending on the fragmentation pattern of the polypeptide analyte, for example, a- and x-ions, b- and y-ions, or c- and z-ions. As used herein, the terms “c-ion” and “z-ion” refer to predominant ions observed when a polypeptide is subjected to the analytical technique ETD.

As used herein, the term “top-down” refers to an analytical technique wherein an input sample is a large or intact protein/polypeptide, for example in intact mass analysis. As used herein, the term “bottom-up” refers to an analytical technique wherein an input sample is a protein/polypeptide that has been reduced to small subunits, for example in peptide mapping. As used herein, the term “middle-up” refers to an analytical technique wherein an input sample is a protein/polypeptide that has been reduced to medium sized subunits, for example using digestion of an antibody by IdeS.

As used herein, the term “m/z” or “mass-to-charge ratio” refers to an analytical parameter for characterizing aspects of a polypeptide using, e.g., LC-MS, LC-MS/MS and/or ETD, wherein m stands for mass and z stands for the charge number of ions observed. Specific m/z separation functions can be designed so that in one section of the instrument ions are selected, dissociated in an intermediate region, and the product ions are then transmitted to another analyzer for m/z separation and data acquisition. In tandem-in-time, mass spectrometer ions produced in the ion source can be trapped, isolated, fragmented, and m/z separated in the same physical device.

In some exemplary aspects, the mass spectrometer can work on nanoelectrospray or nanospray. The term “nanoelectrospray” or “nanospray” as used herein refers to electrospray ionization at a very low solvent flow rate, typically hundreds of nanoliters per minute of sample solution or lower, often without the use of an external solvent delivery. The electrospray infusion setup forming a nanoelectrospray can use a static nanoelectrospray emitter or a dynamic nanoelectrospray emitter. A static nanoelectrospray emitter performs a continuous analysis of small sample (analyte) solution volumes over an extended period of time. A dynamic nanoelectrospray emitter uses a capillary column and a solvent delivery system to perform chromatographic separations on mixtures prior to analysis by the mass spectrometer.

A mass spectrometer may use one or more of various fragmentation or analysis techniques, including, for example, collision-induced dissociation (CID), electron-transfer dissociation (ETD), electron-transfer/collision-induced dissociation (ETciD), electron-transfer/higher-energy collisional dissociation (EThcD), or ultra-violet photodissociation (UVPD).

The peptides identified by the mass spectrometer can be used as surrogate representatives of the intact protein and their post-translational modifications. They can be used for protein characterization by correlating experimental and theoretical MS/MS data, the latter generated from possible peptides in a protein sequence database. The characterization includes, but is not limited, to sequencing amino acids of the protein fragments, determining protein sequencing, determining protein de novo sequencing, locating post-translational modifications, or identifying post-translational modifications, or comparability analysis, or combinations thereof.

It is understood that the present disclosure is not limited to any of the aforesaid protein(s), antibody(s), antibody fragment(s), monoclonal antibody(s), bispecific antibody(s), multi-specific antibody(s), sample(s), digestive enzyme(s), hydrolyzing agent(s), protein reducing agent(s), chromatography system(s), or mass spectrometer(s), and any protein(s), antibody(s), antibody fragment(s), monoclonal antibody(s), bispecific antibody(s), multi-specific antibody(s), sample(s), digestive enzyme(s), hydrolyzing agent(s), protein reducing agent(s), chromatography system(s), or mass spectrometer(s) can be selected by any suitable means.

The present disclosure will be more fully understood by reference to the following Examples. They should not, however, be construed as limiting the scope of this disclosure.

In an exemplary embodiment, a sample including a protein and at least one free thiol species thereof may be subjected to hydrophilic interaction chromatography-mass spectrometry (HILIC-MS) analysis to characterize the free thiol groups. The disclosed systems and methods for characterizing free thiol groups in a protein may be used to inform the manufacturing, formulation, storage, and analysis of therapeutic proteins.

In another exemplary embodiment, a method is provided for characterizing free thiols in a protein, including subjecting a sample including a protein and at least one free thiol species thereof to deglycosylating conditions to form a deglycosylated sample; subjecting the deglycosylated samples to hydrophilic interaction chromatography to form an eluate; subjecting the eluate to mass spectrometry analysis to obtain mass measurements of the protein and the at least one free thiol species; and comparing the mass measurements of the at least one free thiol species to the mass measurements of the protein to characterize the free thiols.

In another exemplary embodiment, a method is provided for characterizing free thiols in a protein, including subjecting a sample including a protein and at least one free thiol species thereof to hydrophilic interaction chromatography to form an eluate; subjecting the eluate to mass spectrometry analysis to obtain mass measurements of the protein and the at least one free thiol species; and comparing the mass measurements of the at least one free thiol species to the mass measurements of the protein to characterize the free thiols.

In one aspect, the protein is a monoclonal antibody, a bispecific antibody, an antibody fragment, an antibody-drug conjugate, a fusion protein, or a recombinant protein. In one aspect, subjecting a sample including a protein and a free thiol species thereof to deglycosylating condition comprises contacting the sample to PNGase. In another aspect, the hydrophilic interaction chromatography system is coupled to the mass spectrometer. In another aspect, mass spectrometry comprises an electrospray ionization mass spectrometer, a nano-electrospray ionization mass spectrometer, or an Orbitrap-based mass spectrometer.

In another exemplary embodiment, a method is provided for identifying free thiol residues in a protein, including subjecting a sample including a protein and at least one free thiol species thereof to deglycosylating conditions to form a deglycosylated sample; subjecting the deglycosylated samples to hydrophilic interaction chromatography to form an eluate; and subjecting the eluate to mass spectrometry analysis to identify the at least one free thiol species.

In another exemplary embodiment, a method is provided for identifying free thiol residues in a protein, including subjecting a sample including a protein and at least one free thiol species thereof to hydrophilic interaction chromatography to form an eluate; and subjecting the eluate to mass spectrometry analysis to identify the at least one free thiol species.

In one aspect, the protein is a monoclonal antibody, a bispecific antibody, an antibody fragment, an antibody-drug conjugate, a fusion protein, or a recombinant protein. In another aspect, subjecting a sample including a protein and a free thiol species thereof to deglycosylating condition comprises contacting the sample to PNGase. In another aspect, the hydrophilic interaction chromatography system is coupled to the mass spectrometer. In another aspect, mass spectrometry comprises an electrospray ionization mass spectrometer, a nano-electrospray ionization mass spectrometer, or an Orbitrap-based mass spectrometer. In another aspect, mass spectrometry analysis comprises tandem mass spectrometry analysis. In another aspect, the tandem mass spectrometry analysis comprises electron-transfer dissociation, collision-induced dissociation, electron-transfer/collision-induced dissociation, electron-transfer/higher-energy collisional dissociation, ultra-violet photodissociation, or a combination thereof.

In another exemplary embodiment, a method is provided for characterizing free thiols in a therapeutic antibody, including subjecting a sample including a therapeutic antibody and at least one free thiol species thereof to deglycosylating conditions to form a deglycosylated sample; subjecting the deglycosylated sample to digestion conditions to form a fragmented sample; subjecting the fragmented sample to complete or partial reduction to form a reduced sample; subjecting the reduced samples to hydrophilic interaction chromatography to form an eluate; subjecting the eluate to mass spectrometry analysis to obtain mass measurements of the therapeutic antibody and the at least one free thiol species; and comparing the mass measurements of the at least one free thiol species to the mass measurements of the therapeutic antibody to characterize the at least one free thiol species.

In one aspect, the therapeutic antibody is a monoclonal antibody, a bispecific antibody, an antibody fragment, an antibody-drug conjugate, a fusion protein, or a recombinant protein.

In another aspect, subjecting a sample including a protein and a free thiol species thereof to deglycosylating condition comprises contacting the sample to PNGase. In another aspect, subjecting the deglycosylated sample to digestion conditions includes contacting the deglycosylated sample to a digestive enzyme. In another aspect, the digestive enzyme is IdeS or a variant thereof.

In another aspect, the fragmented sample comprises antibody subunits, wherein the subunits are selected from a group consisting of light chain, heavy chain, Fab, Fab′, Fab₂, F(ab′)₂, Fc, Fc/2, Fv, Fd, and Fd′. In another aspect, the partial reduction disrupts the inter-chain disulfide bonds of the protein. In another aspect, subjecting the fragmented sample to partial reduction comprises contacting the fragmented sample to a reducing agent selected from the group consisting of dithiothreitol, β-mercaptoethanol, Ellman's reagent, hydroxylamine hydrochloride, and tris(2-carboxyethyl)phosphine hydrochloride.

In another aspect, the hydrophilic interaction chromatography system is coupled to the mass spectrometer. In another aspect, mass spectrometry comprises an electrospray ionization mass spectrometer, a nano-electrospray ionization mass spectrometer, or an Orbitrap-based mass spectrometer.

In another exemplary embodiment, a method is provided for identifying at least one free thiol species in a therapeutic antibody, including subjecting a sample including a therapeutic antibody and at least one free thiol species thereof to deglycosylating conditions to form a deglycosylated sample; subjecting the deglycosylated sample to digestion conditions to form a fragmented sample; subjecting the fragmented sample to complete or partial reduction to form a reduced sample; subjecting the reduced samples to hydrophilic interaction chromatography to form an eluate; and subjecting the eluate to mass spectrometry analysis to identify the at least one free thiol species.

In one aspect, the protein is a monoclonal antibody, a bispecific antibody, an antibody fragment, an antibody-drug conjugate, a fusion protein, or a recombinant protein. In another aspect, subjecting a sample including a protein and a free thiol species thereof to deglycosylating condition comprises contacting the sample to PNGase. In another aspect, subjecting the deglycosylated sample to digestion conditions includes contacting the deglycosylated sample to a digestive enzyme. In another aspect, the digestive enzyme is IdeS or a variant thereof.

In another aspect, the fragmented sample comprises subunits of the therapeutic antibody, wherein said subunits are selected from a group consisting of light chain, heavy chain, Fab, Fab′, Fab₂, F(ab′)₂, Fc, Fc/2, Fv, Fd, and Fd′. In another aspect, the partial reduction disrupts the inter-chain disulfide bonds of the protein. In another aspect, subjecting the fragmented sample to partial reduction comprises contacting the fragmented sample to a reducing agent selected from the group consisting of dithiothreitol, β-mercaptoethanol, Ellman's reagent, hydroxylamine hydrochloride, and tris(2-carboxyethyl)phosphine hydrochloride.

In another aspect, the hydrophilic interaction chromatography system is coupled to the mass spectrometer. In another aspect, mass spectrometry comprises an electrospray ionization mass spectrometer, a nano-electrospray ionization mass spectrometer, or an Orbitrap-based mass spectrometer. In another aspect, mass spectrometry analysis comprises tandem mass spectrometry analysis. In another aspect, tandem mass spectrometry analysis comprises electron-transfer dissociation, collision-induced dissociation, electron-transfer/collision-induced dissociation, electron-transfer/higher-energy collisional dissociation, ultra-violet photodissociation, or a combination thereof.

In another exemplary embodiment, a method is provided for detecting at least one free thiol species of a therapeutic antibody, including subjecting a sample including a therapeutic antibody and at least one free thiol species thereof to deglycosylating conditions to form a deglycosylated sample; subjecting the deglycosylated sample to digestion conditions to form a fragmented sample; subjecting the fragmented sample to complete or partial reduction to form a reduced sample; and subjecting the reduced samples to hydrophilic interaction chromatography to detect the at least one free thiol species.

In one aspect, the protein is a monoclonal antibody, a bispecific antibody, an antibody fragment, an antibody-drug conjugate, a fusion protein, or a recombinant protein. In one aspect, subjecting a sample including a protein and a free thiol species thereof to deglycosylating condition comprises contacting the sample to PNGase. In another aspect, subjecting the deglycosylated sample to digestion conditions includes contacting the deglycosylated sample to a digestive enzyme. In another aspect, the digestive enzyme is IdeS or a variant thereof.

In another aspect, the fragmented sample comprises antibody subunits, wherein the subunits are selected from a group consisting of light chain, heavy chain, Fab, Fab′, Fab₂, F(ab′)₂, Fc, Fc/2, Fv, Fd, and Fd′. In another aspect, the partial reduction disrupts the inter-chain disulfide bonds of the protein. In another aspect, subjecting the fragmented sample to partial reduction comprises contacting the fragmented sample to a reducing agent selected from the group consisting of dithiothreitol, β-mercaptoethanol, Ellman's reagent, hydroxylamine hydrochloride, and tris(2-carboxyethyl)phosphine hydrochloride.

In another aspect, mass spectrometry comprises an electrospray ionization mass spectrometer, a nano-electrospray ionization mass spectrometer, or an Orbitrap-based mass spectrometer.

### EXAMPLES

Materials. Purified monoclonal and bispecific antibodies were produced internally by Regeneron (Tarrytown, NY). Peptide-N-Glycosidase F (PNGase F, #P0704L) was purchased from New England Biolabs (Ipswich, MA) and FabRICATOR (IdeS) protease was purchased from Genovis (Cambridge, MA). 1 M Tris-hydrochloride pH 7.5 solution (#15567-027) was purchased from Invitrogen (Carlsbad, CA), dithiothreitol (DTT, #20291) was purchased from Thermo Fisher Scientific (Waltham, MA). Acetonitrile (LC-MS grade, #A955-4) and trifluoroacetic acid (TFA, #PI28904) were purchased from Fisher Scientific (Hampton, NH). Milli-Q water was provided in-house.

Sample preparation. The antibodies were diluted to a final concentration of 5 mg/L in 100 mM Tri-HCl (pH 7.5). PNGase F was added at an enzyme-to-substrate ratio of 1 unit/10 g protein and the deglycosylation reaction was conducted at 45° C. for 1 hour. The antibodies were then digested with FabRICATOR® Tris-HCl at 37° C. for 1 hour. To initiate the limited reduction by DTT, a 20 μg aliquot of the digested sample was reduced with 5 mM DTT before injection onto the HILIC column for online UV and mass spectrometry analysis. The injection volume was 1.5 μg for all samples.

HILIC-FLR and HILIC-MS/MS Methods. HILIC separation was performed on Waters ACQUITY UPLC system equipped with a Waters ACQUITY Premier Glycoprotein BEH Amide column (300 Å, 1.7 μm, 2.1×150 mm). The column was operated at 80° C. The mobile phases were 0.1% TFA in water as A, 0.1% TFA in acetonitrile as B, and the flow rate was set to 0.2 mL/min. The FLR traces were recorded using an excitation and emission wavelengths of 280 and 348 nm, respectively. The separation was achieved over 40 minutes with an initial 0.5-minute hold at 15% A, followed by an increase to 25% A over the next 0.5 minute, and another linear increase to 35% A over the next 26 minutes. The gradient was then ramped to 100% A over 1 minute and held for 1 minute, before dropping to 15% A in 1 minute, and then maintained at initial condition for over 10 minutes to equilibrate the column for the next run.

To enable online MS/MS analysis, the Waters ACQUITY UPLC system was directly coupled to a Thermo Scientific Q Exactive hybrid quadrupole Orbitrap mass spectrometer (Thermo Fisher Scientific, Waltham, MA). The capillary voltage was set at 4.0 kV, with a sheath gas flow rate of 40 arbitrary units and auxiliary gas flow rate of 15 arbitrary units. The capillary temperature was set at 350° C. and the probe heater temperature was set at 400° C. To counteract TFA-sensitivity loss, a desolvation gas modification device, delivering a dopant gas containing a 3:1 (v/v) ratio of propionic acid (PA) and isopropanol (IPA), was implemented on the ion source. During MS² experiments, higher-energy C-trap dissociation (HCD) was employed for peptide fragmentation. The mass spectra were acquired with an m/z mass range window between 800 and 4000 m/z. The top three charge states of each species were selected for MS/MS analysis and were fragmented by higher-energy collisional dissociation (HCD) with a normalized collision energy (NCE) set at 30%.

Data analysis. The extracted ion chromatograms (XIC) peak was integrated using Thermo Fisher Xcalibur software. Intact mass spectra deconvolution and XIC-based quantitation were carried out using Protein Metrics' Intact Mass software. MS² fragmentation mapping was performed using the ProSight Native software from Proteinaceous.

### Example 1: Identification and Localization of Intrachain Free Thiol

A recombinant monoclonal antibody (mAb) was used as a model molecule. First, mAb was digested with a variant of digestive enzyme IdeS, FABRICATOR@, which cleaves the mAb molecule under the hinge region, to generate the F(ab)′₂ and Fc (consisting of two non-covalently interacting Fc/2) fragments. Following this, partial reduction with DTT was applied to disrupt the inter-chain disulfide bonds (HC—HC and HC-LC) and further reduce F(ab)′₂ to Fab (consisting of non-covalently interacting Fd and LC subunits). Due to the absence of inter-chain disulfide bonds between Fd and LC, the non-covalent dimers were dissociated into subunit fragments (i.e., Fd, LC, Fc/2).

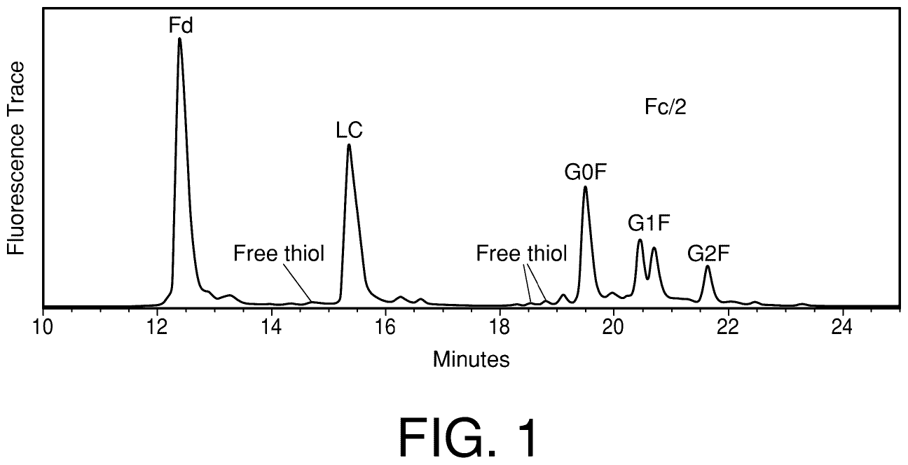

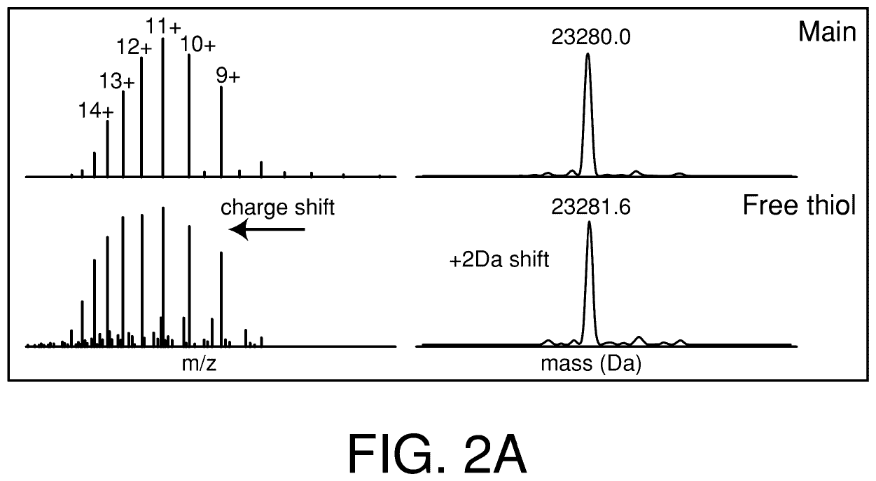

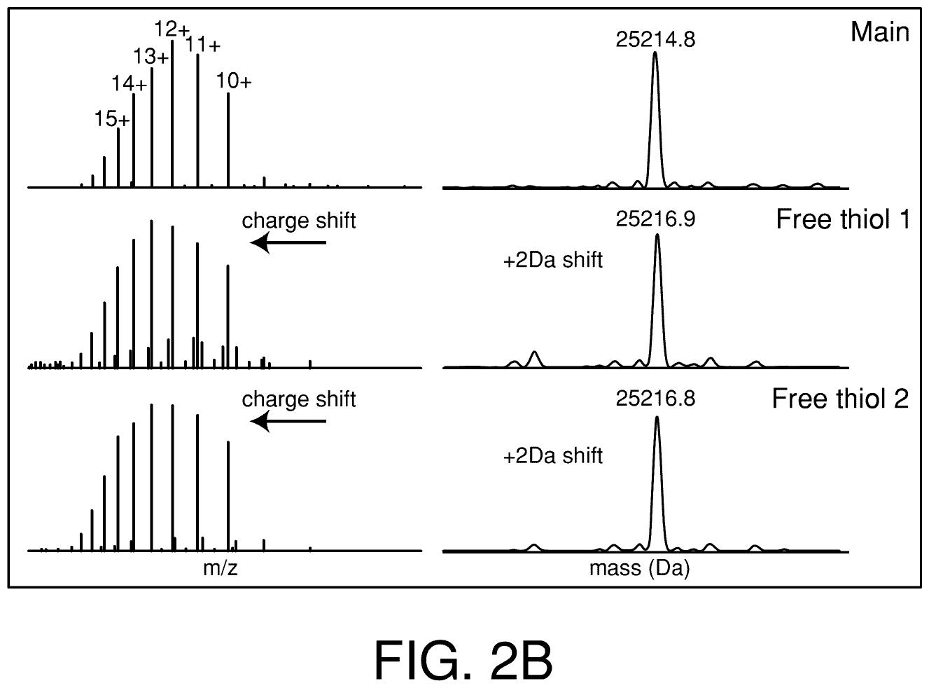

The subunits of mAb were then separated on a HILIC column and analyzed by FLR detection and mass spectrometry analysis, the results of which are shown in FIGS. 1, 2A, and 2B). As shown in the FLR profile (FIG. 1), peaks representing the Fc, LC, and Fc/2 subunits were identified. Additional peaks that eluted earlier than the main peaks were also observed in the FLR profile, which corresponded to the free thiol species of the LC or Fc/2 subunits. The elution order on the HILIC column was correlated with their relative size, with smaller fragments eluting earlier than the larger profile.

MS¹ spectra were obtained for the LC (FIG. 2A) and Fc/2 (FIG. 2B) subunits and its free thiol species. The charge state distribution of the free thiol species was shown to shift towards the higher charge state species compared with the main species, indicating extensive unfolding and increased hydrophobicity. This is consistent with the fact that reduction of disulfide bonds results in loss of the compact secondary structure of proteins and exposure of additional basic residues to protonation under electrospray ionization condition. Comparing the deconvoluted spectra for the free thiol and main peaks, a 2 Da mass increase was observed for the free thiol species, confirming the identification of free thiol species.

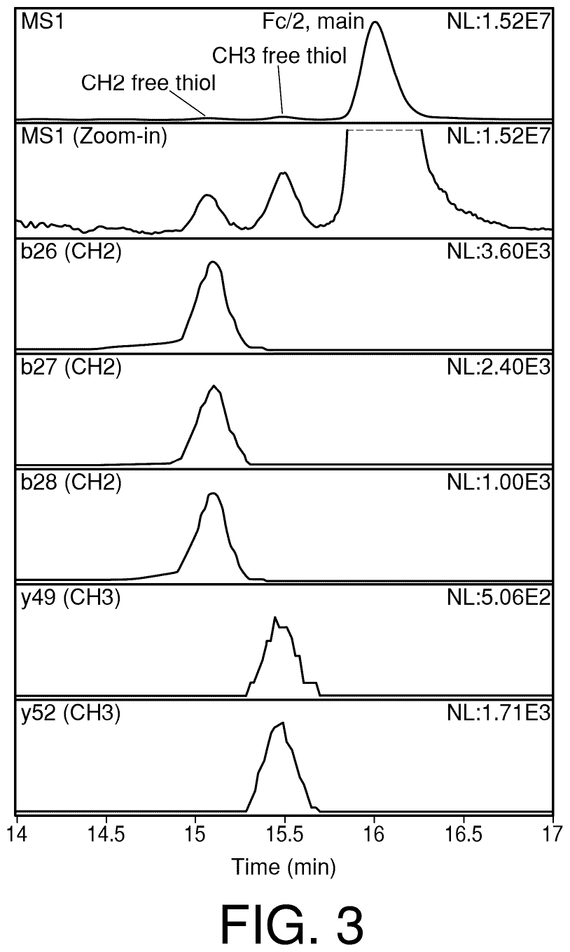

Multiple free thiol species were detected at the MS¹ level for the Fc/2 subunit of mAb (FIG. 2B). In particular, two well-separated free thiol peaks were observed, which were predicted to correspond to the free thiol species of the CH2 and CH3 domain in the Fc subunit. To confirm this hypothesis, the two peaks were further characterized at the MS² level using HCD fragmentation. The XIC of the MS² fragments indicated that the CH2 and CH3 domain exhibit different retention times during HILIC separation (FIG. 3). Comparison of the retention times of the XIC of the MS¹ and MS² spectra confirmed that the first eluting species correlates to the CH2 domain and the second eluting species correlates to the CH3 domain (FIG. 3).

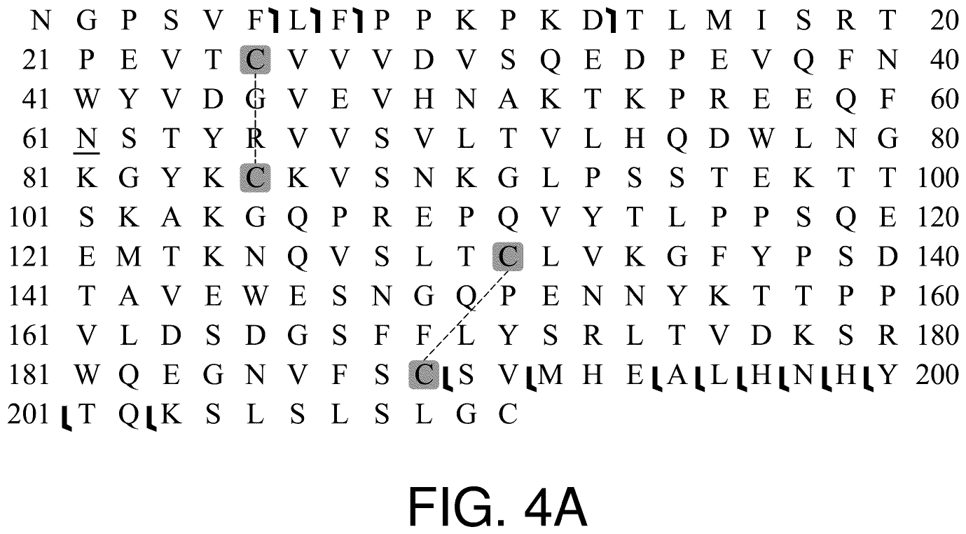

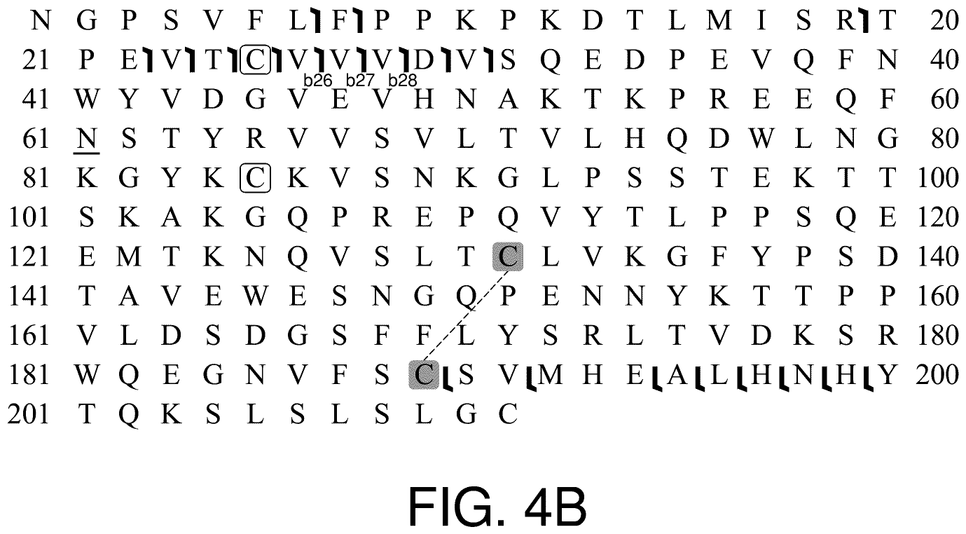

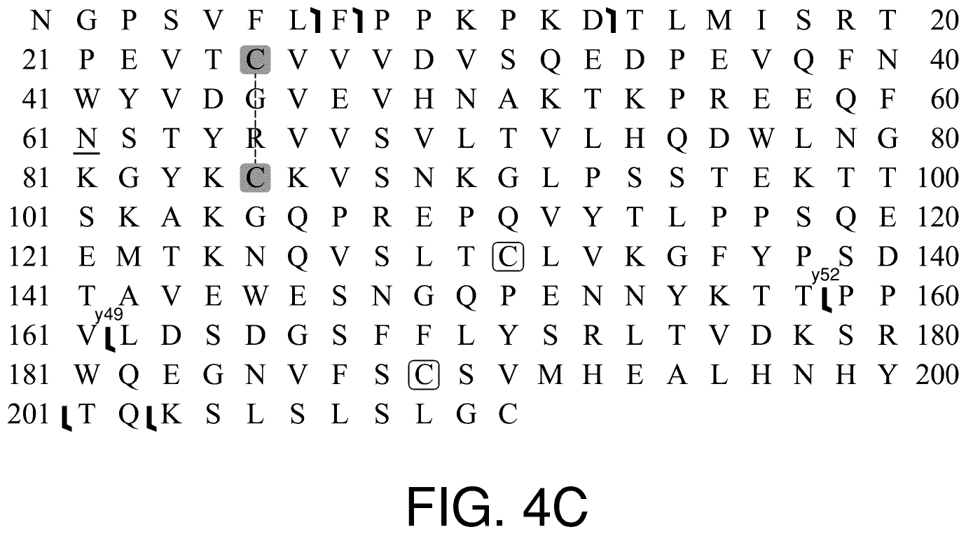

To determine the location of the free thiol groups in the Fc/2 subunit, the disulfide linkages of the Fc/2 main species and the CH2 and CH3 free thiol species were further characterized at the MS² level (FIGS. 4A-4C). For the main species (FIG. 4A), HCD fragmentation primarily occurred at the N- and C-terminus due to disulfide-bond-induced compact folding. In contrast, for the CH2 (FIG. 4B) and CH3 (FIG. 4C) intradomain free thiol species, HCD fragmentation also occurred at free thiol-containing regions. As a result, the free thiol groups were discovered to be located at C85 in the CH2 domain and C131 and C189 in the CH3 domain of the Fc/2 subunit.

### Example 2: Quantification of Free Thiols

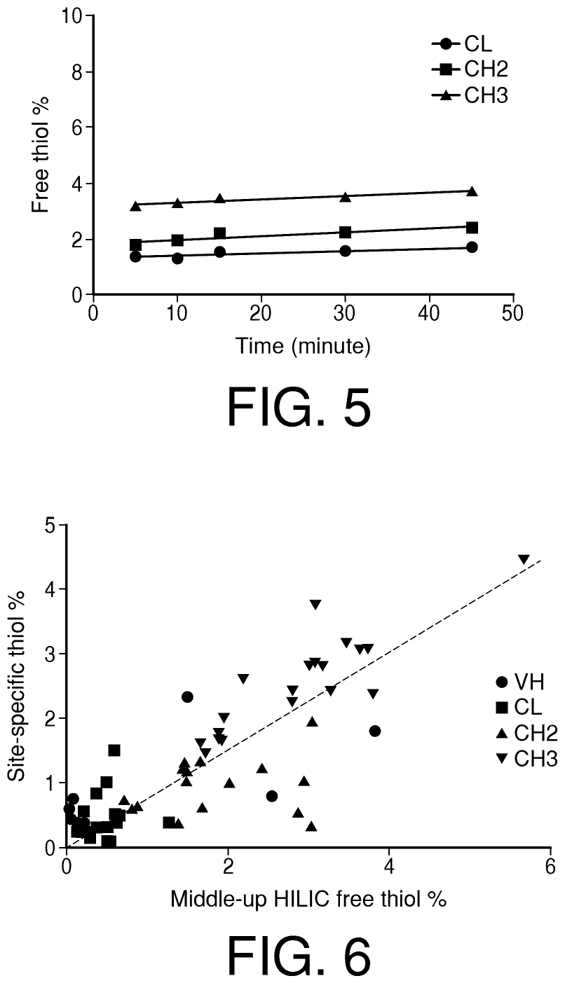

To demonstrate that the HILIC-MS method could be used to quantify free thiols, the effects of DTT exposure time on free thiol formation was evaluated. The CL, CH2, and CH3 domains of mAb were treated with DTT at various time points, from 5 minutes to 45 minutes. As shown in FIG. 5, no significant changes were observed in the free thiol levels of the CL, CH2 and CH3 domain from 5 to 45 minutes. This suggests that the conditions used for partial reduction does not impact the intradomain disulfide bond, thus providing a reliable method for intradomain free thiol quantitation.

The quantitation performance of middle up HILIC-MS was compared to a site-specific approach (FIG. 6). Using both HILIC-MS and the site-specific approach, the percentage of free thiol species for VH, CL, CH2, and CH3 domains of mAb were determined. When comparing the percentage of free thiol species obtained by the two methods, a strong correlation was observed, suggesting that the HILIC-MS method offers accurate quantitation of free thiol groups.

### Example 3: Evaluation of Free Thiol Species in Process Development

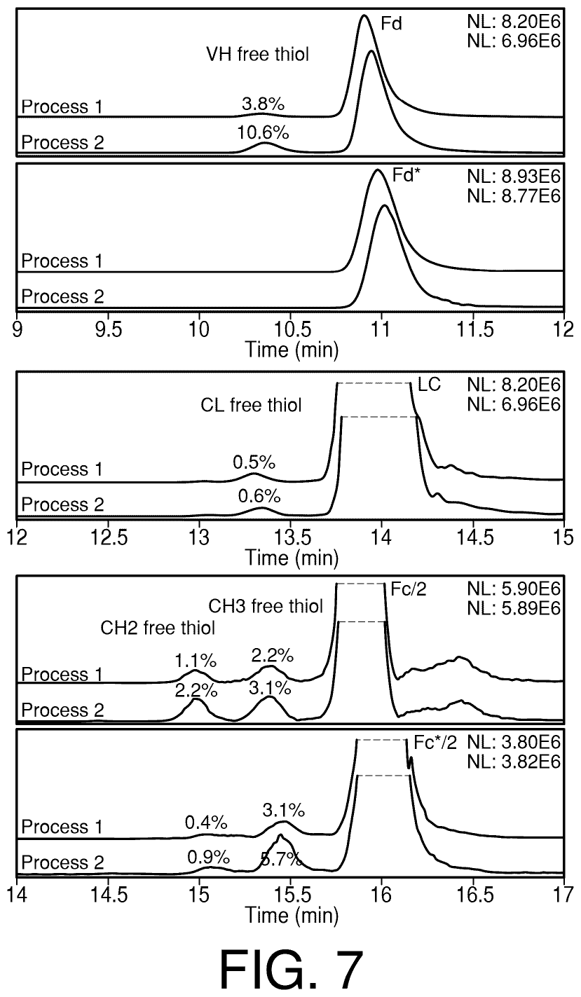

The HILIC-MS method was used to compare the levels of thiol species in process-related materials. A bispecific antibody sample produced from two different processes, Process 1 and Process 2, was used for this comparison. Similar to the sample preparation described in the Example 1, the bispecific antibody was deglycosylated, digested, and then partially reduced to generate the Fd, LC, and Fc/2 subunits. The subunits of the bispecific antibody —Fd, Fd*, LC, Fc/2, and Fc*/2—were then separated on a HILIC column and analyzed by FLR detection, the results of which are shown in FIG. 7. The peaks representing the Fd, Fd*, LC, Fc/2, and Fc*/2 subunits, and its corresponding free thiol species (VH, CL, and CH2/CH3) were identified. To determine the percentage of free thiol species for each subunit, the area of each free thiol peak was quantified relative to the sum of the peaks representing the same subunit. A significant increase in the VH free thiol species was observed in the sample from Process 2 relative to the sample from Process 1. In contrast, no significant changes in the Fd* VH, LC CL, and CH2/CH3 free thiol species were found between the samples obtained from Process 1 and Process 2.

The new middle-up HILIC-MS method can be used to characterize free thiols of a protein in a domain-specific manner. This method uses simple sample preparation and easy analysis, providing an efficient method for localizing and quantifying free thiols. As demonstrated above, this method is highly valuable for characterizing free thiols in therapeutic antibody products.

While in the foregoing disclosure has been described in relation to certain embodiments thereof, and many details have been put forth for the purpose of illustration, it will be apparent to those skilled in the art that the present invention is susceptible to additional embodiments and that certain details described herein can be varied without departing from the basic principles of the present disclosure.

1. A method for characterizing free thiol species in a protein, the method comprising:
contacting a sample including a protein and at least one free thiol species thereof to a hydrophilic interaction chromatography (HILIC) system to produce an eluate;
contacting the eluate to a mass spectrometer to generate a mass measurement of the protein and a mass measurement of the at least one free thiol species; and
comparing the mass measurement of the at least one free thiol species to the mass measurement of the protein to characterize the at least one free thiol species.

2. The method of claim 1, wherein the protein is an antibody, an antibody fragment, an antibody-drug conjugate, a fusion protein, or a recombinant protein.

3. The method of claim 2, wherein the antibody is a monoclonal antibody.

4. The method of claim 2, wherein the antibody is a bispecific antibody.

5. The method of claim 1, wherein the HILIC system is coupled to the mass spectrometer.

6. The method of claim 1, wherein the mass spectrometer is an electrospray ionization mass spectrometer, a nano-electrospray ionization mass spectrometer, or an Orbitrap-based mass spectrometer.

7. The method of claim 1, wherein the mass spectrometer is a tandem mass spectrometer.

8. The method of claim 7, wherein the tandem mass spectrometer is configured to perform electron-transfer dissociation, collision-induced dissociation, electron-transfer/collision-induced dissociation, electron-transfer/higher-energy collisional dissociation, ultra-violet photodissociation, or a combination thereof.

9. The method of claim 1, wherein contacting the eluate to a mass spectrometer to generate a mass measurement of the protein and a mass measurement of the at least one free thiol species comprises:
generating a mass spectrum for the protein and a mass spectrum for the at least one free thiol species.

10. The method of claim 1, wherein contacting the eluate to a mass spectrometer to generate a mass measurement of the protein and a mass measurement of the at least one free thiol species comprises:
generating, for the protein, a mass spectrum and an extracted ion chromatogram; and
generating, for the at least one free thiol species, a mass spectrum and an extracted ion chromatogram.

11. A method for characterizing free thiol species in a protein, the method comprising:
contacting a sample including a protein and at least one free thiol species thereof to deglycosylation conditions to produce a deglycosylated sample;
contacting the deglycosylated sample to a hydrophilic interaction chromatography (HILIC) system to produce an eluate;
contacting the eluate to a mass spectrometer to generate a mass measurement of the protein and a mass measurement of the at least one free thiol species; and
comparing the mass measurement of the at least one free thiol species to the mass measurement of the protein to characterize the at least one free thiol species.

12. The method of claim 11, wherein the protein is an antibody, an antibody fragment, an antibody-drug conjugate, a fusion protein, or a recombinant protein.

13. The method of claim 12, wherein the antibody is a monoclonal antibody.

14. The method of claim 12, wherein the antibody is a bispecific antibody.

15. The method of claim 11, wherein the HILIC system is coupled to the mass spectrometer.

16. The method of claim 11, wherein the mass spectrometer is an electrospray ionization mass spectrometer, a nano-electrospray ionization mass spectrometer, or an Orbitrap-based mass spectrometer.

17. The method of claim 11, wherein the mass spectrometer is a tandem mass spectrometer.

18. The method of claim 17, wherein the tandem mass spectrometer is configured to perform electron-transfer dissociation, collision-induced dissociation, electron-transfer/collision-induced dissociation, electron-transfer/higher-energy collisional dissociation, ultra-violet photodissociation, or a combination thereof.

19. The method of claim 1, wherein contacting a sample including a protein and at least one free thiol species thereof to deglycosylation conditions to produce a deglycosylated sample comprises:
contacting the sample to an enzyme that can carry out deglycosylation.

20. The method of claim 1, wherein contacting a sample including a protein and at least one free thiol species thereof to deglycosylation conditions to produce a deglycosylated sample comprises:
contacting the sample to peptide-N-glycosidase F (PNGase F).
